(19) United States
(12) Patent Application Publication
(10) Pub. No.: US 2010/0198999 A1
(43) Pub. Date: Aug. 5, 2010

(54) METHOD AND SYSTEM FOR WIRELESS USB TRANSFER OF ISOCHRONOUS DATA USING BULK DATA TRANSFER TYPE

(75) Inventors: Anoop Nair, Allen, TX (US); Criag Smith, Allen, TX (US); Greg Christison, Fairview, TX (US); Thomas R. Miller, Plano, TX (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/366,591

(22) Filed: Feb. 5, 2009

(51) Int. Cl. G06F 13/14

(52) U.S. Cl. 710/33

(57) ABSTRACT

A method and system for transferring data in a wireless USB system having a first USB enabled device and a second USB enabled device are provided. The method includes providing a first data having a first data transfer type, converting the first data to a second data having a second data transfer type, wirelessly transferring the second data from the first USB enabled device to the second USB enabled device using the second data transfer type, and converting the wirelessly transferred second data to a third data having the first data transfer type.

### CLAIM OF PRIORITY UNDER 35 U.S.C. §119

The present Application for Patent claims benefit of Provisional Application Ser. No. 61/026,969, entitled, “Method and System for Wireless USB Transfer of Isochronous Data using Bulk Data Transfer Type,” filed Feb. 7, 2008, and assigned to the assignee hereof and hereby expressly incorporated by reference herein.

### BACKGROUND

The wired Universal Serial Bus (USB) specification supports four basic types of data transfers: control, bulk data, interrupt data, and isochronous data transfers. Control data transfer is used for bursty, non-periodic, host software-initiated request/response communication, typically used for command/status operations. Bulk data transfer is non-periodic, large-packet bursty communication, typically used for data that can use any available bandwidth and can also be delayed until bandwidth is available. For example, a printer, which receives data in one big packet, uses the bulk transfer data type. Interrupt data transfer is used for low-frequency, bounded-latency communication. For example, a device such as a mouse or keyboard, which will be sending very little data, would use the interrupt data transfer type. Isochronous data transfer type, also known as streaming real time transfer, is used for periodic, continuous communication between a host and a device, and is typically used for time-relevant information. A streaming device, such as an audio speaker, uses the isochronous data transfer type.

The Wireless Universal Serial Bus (WUSB) specification includes descriptions and specifications of devices known as Wire Adapters. These devices are wired-USB-to-Wireless-USB adapters which allow “legacy” wired USB hosts and devices to be interconnected with WUSB devices in extended USB systems containing both wired and wireless links. There are two types of Wire Adapters: Host Wire Adapter (HWA) and Device Wire Adapter (DWA) which work in conjunction with each other. HWAs have a wired “upstream” USB port and a wireless “downstream” WUSB port, allowing a wired USB host to communicate with WUSB devices. DWAs have a wireless “upstream” WUSB port and one or more wired “downstream” USB ports, allowing wired USB devices to communicate with a WUSB host. Therefore, WUSB systems with “legacy” wired USB hosts and devices will employ HWAs and DWAs.

The WUSB specification supports the same data transfer types as wired USB. In particular, WUSB supports control, bulk data, interrupt data, and isochronous data transfer types. WUSB bulk data transfer maintains its simplicity from wired USB bulk data transfer. However, because of the nature of wireless communications, WUSB isochronous data transfer requires added complexity over wired USB isochronous data transfer. Therefore, it would be desirable to have a method and system for providing isochronous data transfers to “legacy” wired USB devices using bulk transfers on the Wireless USB link.

### SUMMARY

A method and system is provided for transferring data in a WUSB system having a first USB enabled device and a second USB enabled device. The method includes providing a first data having a first data transfer type, converting said first data to a second data having a second data transfer type, wirelessly transferring said second data from said first USB enabled device to said second USB enabled device using said second data transfer type, and converting said wirelessly transferred second data to a third data having said first data transfer type.

The system includes a first USB enabled device that includes a first conversion module configured to convert said first data having said first data transfer type to a second data having a second data transfer type, and a first transceiver adapted to wirelessly transfer said second data from said first USB enabled device to said second USB. The system further includes a second USB enabled device that includes a second conversion module configured to convert said wirelessly transferred second data to a third data having said first data transfer type, and a second transceiver adapted to wirelessly receive said second data from said first USB enabled device.

Certain embodiments provide a method for transferring data. The method generally includes embedding a plurality of isochronous data packets in bulk data packets and wirelessly transferring the bulk data packets.

Certain embodiments provide a method for transferring data. The method generally includes receiving bulk data packets, extracting, from the bulk data packets, isochronous data packets, and transferring said isochronous data packets to a universal serial bus (USB) enabled device.

Certain embodiments provide an apparatus for transferring data. The apparatus generally includes a converter for embedding a plurality of isochronous data packets in bulk data packets and a transmitter for wirelessly transferring the bulk data packets.

Certain embodiments provide an apparatus for transferring data. The apparatus generally includes a receiver for receiving bulk data packets, a converter for extracting, from the bulk data packets, isochronous data packets, and a transmitter for transferring said isochronous data packets to a universal serial bus (USB) enabled device.

Certain embodiments provide an apparatus for transferring data. The apparatus generally includes means for embedding a plurality of isochronous data packets in bulk data packets and means for wirelessly transferring the bulk data packets.

Certain embodiments provide an apparatus for transferring data. The apparatus generally includes means for receiving bulk data packets, means for extracting, from the bulk data packets, isochronous data packets, and means for transferring said isochronous data packets to a universal serial bus (USB) enabled device.

Certain embodiments provide a computer-program product for transferring data, comprising a computer readable medium encoded with instructions executable to embed a plurality of isochronous data packets in bulk data packets and wirelessly transfer the bulk data packets.

Certain embodiments provide a computer-program product for transferring data, comprising a computer readable medium encoded with instructions executable to receive bulk data packets, extract, from the bulk data packets, isochronous data packets, and transfer said isochronous data packets to a universal serial bus (USB) enabled device.

Certain embodiments provide a wireless adapter. The wireless adapter generally includes an antenna, a converter for embedding a plurality of isochronous data packets in bulk data packets, and a transmitter for wirelessly transferring the bulk data packets using the antenna.

Certain embodiments provide a wireless adapter. The wireless adapter generally includes an antenna, a receiver for receiving bulk data packets via the antenna, a converter for extracting, from the bulk data packets, isochronous data packets, and a transmitter for transferring said isochronous data packets to a universal serial bus (USB) enabled device.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. Furthermore, all features may not be shown in all drawings for simplicity.

FIG. 1 is a diagrammatic representation of a system in which embodiments disclosed herein may be implemented.

FIG. 2 is a diagrammatic representation of data being transferred that may be implemented in the WUSB system of FIG. 1.

FIG. 3 is a flowchart depicting a method for transferring data that may be implemented in the WUSB system of FIG. 1.

FIG. 4 is a flowchart of a method for converting data that may be implemented in the method of FIG. 3.

FIG. 5 is a flowchart of alternative method for converting data that may be implemented in the method of FIG. 3.

FIG. 6A and FIG. 6B illustrate an example Isochronous data transfer and a corresponding bulk data transfer, respectively, according to certain aspects of the present disclosure.

FIG. 7 illustrates example operations for Isochronous (OUT) data transfer from a host to a device, via Wireless USB bulk data transfer, according to certain aspects of the present disclosure.

FIG. 8 illustrates a diagram of Isochronous (OUT) data transfer from a host to a device, via Wireless USB bulk data transfer, according to certain aspects of the present disclosure.

FIG. 9 illustrates example operations for Isochronous (IN) data transfer from a device to a host, via Wireless USB bulk data transfer, according to certain aspects of the present disclosure.

FIG. 10 illustrates a diagram of Isochronous (IN) data transfer from a host to a device, via Wireless USB bulk data transfer, according to certain aspects of the present disclosure.

### DETAILED DESCRIPTION

Various aspects of the invention are described more fully hereinafter with reference to the accompanying drawings. This invention may, however, be embodied in many different forms and should not be construed as limited to any specific structure or function presented throughout this disclosure. Rather, these aspects are provided so that this disclosure will be thorough and complete, and will fully convey the scope of the invention to those skilled in the art. Based on the teachings herein one skilled in the art should appreciate that the scope of the invention is intended to cover any aspect of the invention disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect of the invention disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

The present disclosure relates generally to the transmission of isochronous data using bulk data transfer type in a wireless USB (WUSB) system. It is understood, however, that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

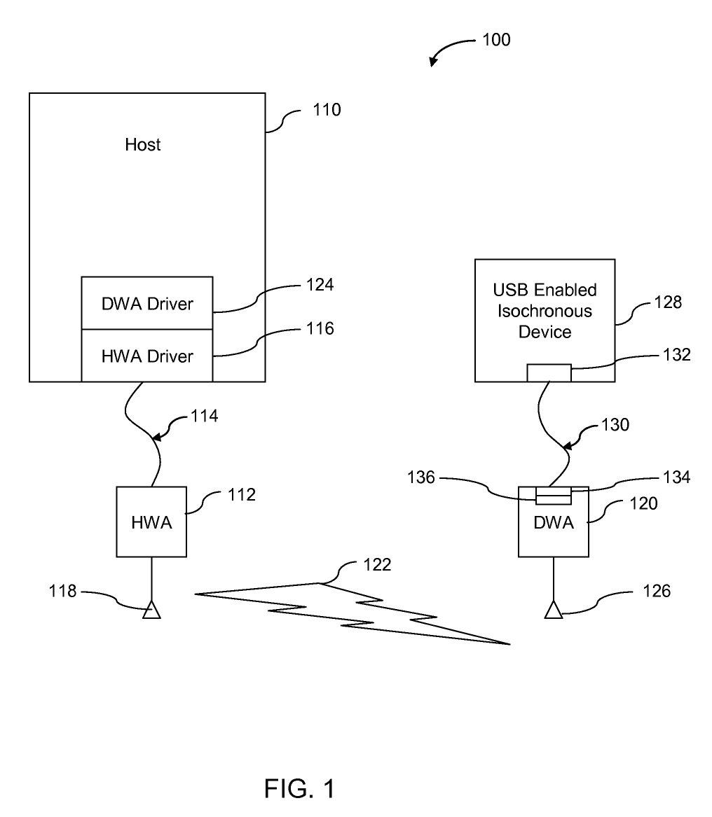

Referring to FIG. 1, a system 100 is an example of a WUSB system that can benefit from one or more embodiments of the present disclosure. The system 100 includes a USB enabled host device 110, such as a computer or laptop having at least one USB port. The host 110 is connected to a host wire adapter (HWA) 112 through a USB port. The host 110 and the HWA 112 communicate over USB wire 114. The HWA 112 provides the host 110 with WUSB functionality.

The host 110 includes a HWA driver 116 that provides software that facilitates communication involving the HWA 112. The HWA 112 includes a wireless transceiver 118. The HWA 112 uses the transceiver 118 to communicate wirelessly with a device wire adapter (DWA) 120 over a wireless link 122. The HWA 112 communicates with the DWA 120 using the WUSB protocol. The wireless link 122 is established over an ultra-wideband (UWB) spectrum.

Those skilled in the art will appreciate that, rather than utilize a transceiver, separate components may be utilized for transmitting (e.g., a transmitter) and receiving (e.g., a receiver).

The host 110 further includes a DWA driver 124 that facilitates communication involving the DWA 120. The DWA 120 has a wireless transceiver 126 that is used to communicate with the HWA 112 via the HWA transceiver 118. The DWA 120 is connected to a USB enabled isochronous device 128, such as a USB audio speaker. The isochronous device 128 and DWA 120 include an isochronous endpoint, 132 and 134 respectively, which facilitates isochronous transfers between the DWA 120 and isochronous device 128. The DWA 120 further includes an isochronous scheduler 136 that facilitates isochronous transfers from the DWA 120 to the isochronous device 128. In particular, the scheduler 136 delivers isochronous data transfers in a time based manner.

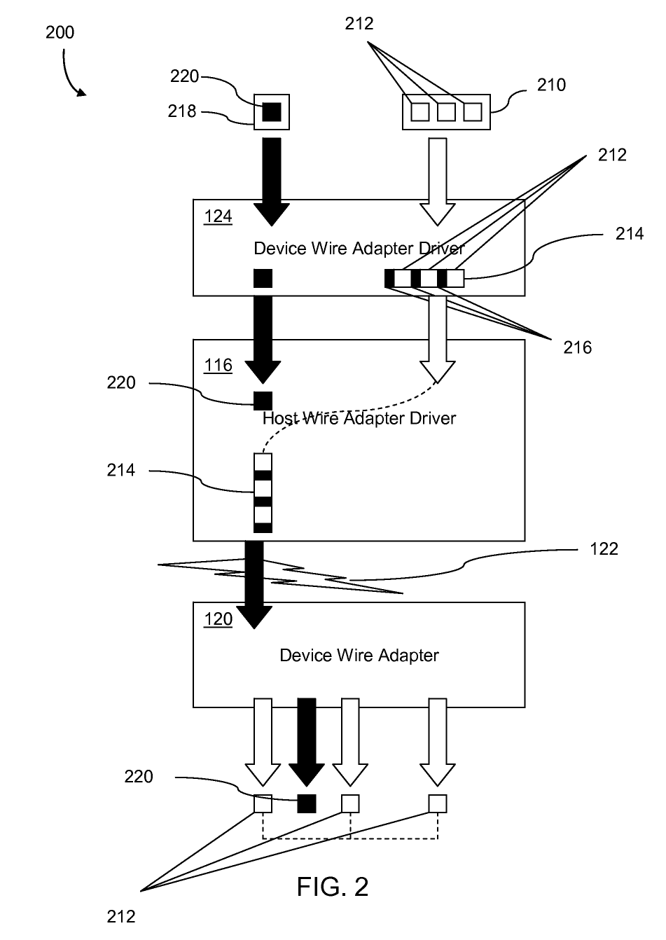

Referring also to FIG. 2, illustrated is a diagrammatic representation of data being transferred in accordance with an embodiment. For example, the diagrammatic representation 200 may be implemented in the WUSB system 100 of FIG. 1. Similar features in FIGS. 1 and 2 are numbered the same for clarity. Initially, the DWA driver 124 recognizes and enumerates the USB isochronous device 128. Thereafter, the DWA driver 124 maps a wire adapter remote pipe declared as isochronous transfer type to isochronous endpoint 132 of DWA 120 associated with the USB isochronous device 128 to a wire adapter remote pipe declared as isochronous transfer type. In addition, the DWA 120 sets up the isochronous endpoint 134 on the DWA 120 as an isochronous scheduled endpoint.

The USB enabled host device 110, such as a laptop, may request an isochronous data transfer 210 to the USB enabled isochronous device 128. When the isochronous data transfer request is made by the host 110, isochronous data transfer having an isochronous data transfer type 210 is provided to the DWA driver 124. The isochronous data transfer 210 consists of isochronous data packets 212. The DWA driver 124 converts the isochronous data packets 212 into isochronous data having a bulk data transfer type 214.

The DWA driver 124 determines the packet lengths 216 corresponding to the respective isochronous data packets 212. The DWA driver 124 then combines the packet lengths 216 with the isochronous data packets 212. The resulting data is an isochronous data having the bulk data transfer type 214. In an embodiment of the present disclosure, the combination of packet lengths 216 with the corresponding isochronous data packets 212 is a concatenation of packet lengths 216 and the corresponding isochronous data packets 212.

This concatenation is repeated iteratively for each isochronous data packet 212 in the isochronous data transfer 210. In an embodiment in accordance with the present disclosure, the DWA driver 124 combines the packet lengths 216 with the isochronous data packets 212 in a manner such that each packet length precedes the corresponding isochronous data packet. The isochronous data having the bulk transfer type 214 is provided to the HWA driver 116 for delivery to the HWA 112.

Thereafter, the HWA 112 wirelessly transfers the isochronous data 214 over the UWB link 122 to the DWA 120 using bulk data transfer. After the DWA 120 receives the isochronous data 214, the DWA 120 converts the data 214 back into isochronous data packets 212, making the data packets 212 suitable for delivery to the USB enabled isochronous device 128.

In one embodiment of the present disclosure, the DWA 120 understands that the isochronous data having the bulk data transfer type 214 is a bulk transfer of aggregated isochronous data packets 212. Accordingly, the DWA 120 separates the isochronous data packets 212 from the isochronous data having the bulk data transfer type 214. The DWA 120 delivers the resulting isochronous data packets 212 to an isochronous endpoint 134 on the DWA 120 to meter out delivery of the isochronous data packets 212 based on an isochronous scheduler 136. According to certain embodiments, the scheduler 136 may meter out delivery of the isochronous data packets according to quality of service and/or traffic parameters defined by the Isochronous endpoint that the data is going to.

In particular, the DWA 120 separates the original isochronous data packets 212 from the isochronous data transfer having the bulk data transfer type 214. After the DWA 120 completes the conversion of the received isochronous data 214 to the isochronous data packets 212, the DWA 120 can deliver the original isochronous data packets 212 to the USB enabled isochronous device 128.

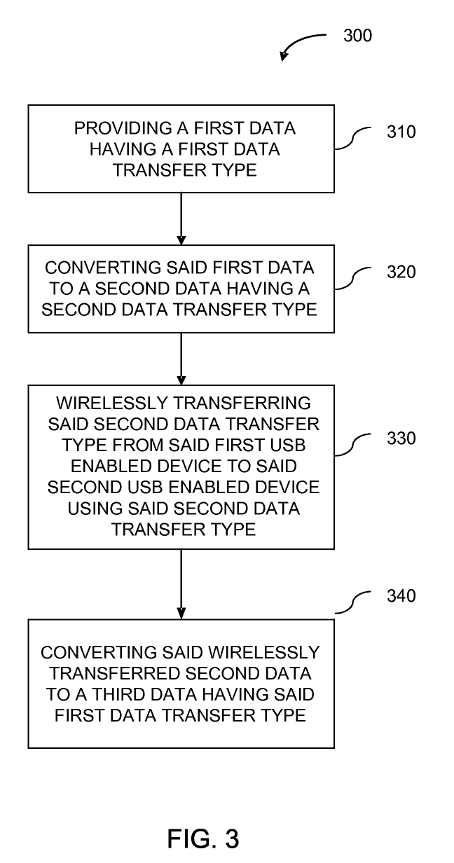

Referring also to FIG. 3, illustrated is a flowchart of a method 300 for wirelessly transferring data in accordance with an embodiment that may be implemented in the system 100 of FIG. 1. According to certain embodiments, the operations of FIG. 3 may be performed to wirelessly transfer data between a host and a USB device, using USB bulk data transfer operations, as if transferred using isochronous data transfer operations via a direct (wired) link between the host and device.

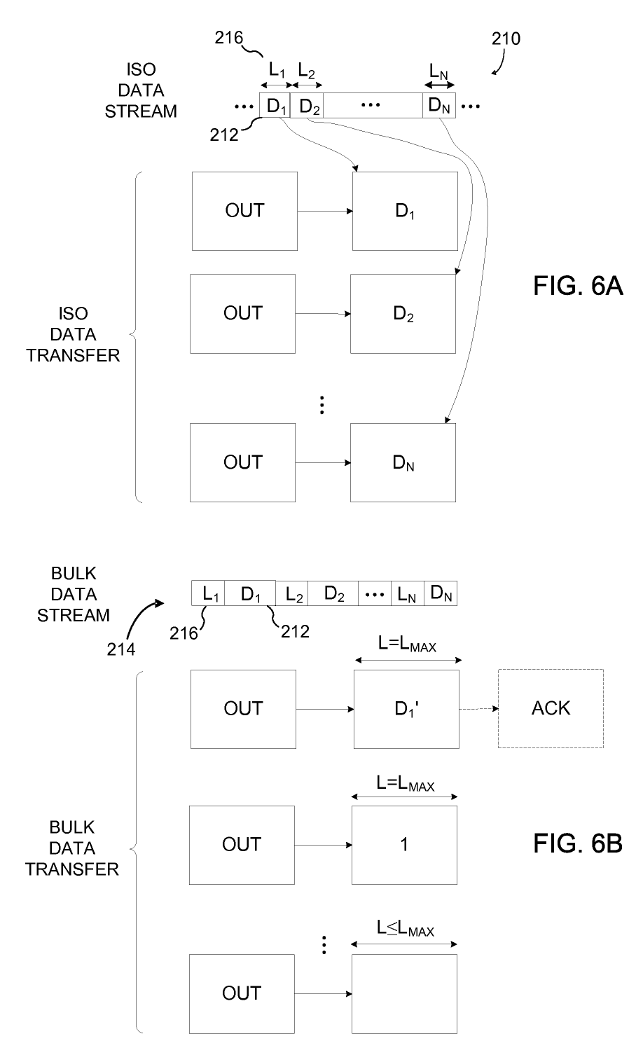

FIG. 6 illustrates a diagram of an example packet exchange between a host device and USB enabled device, via a wireless link between an HWA and DWA, which may correspond to the operations shown in FIG. 3.

The method 300 begins in block 310, by providing a first data (such as isochronous data) having a first data transfer type (such as isochronous data transfer type). In block 320, the method 300 continues by converting the first data to a second data (such as isochronous data) having a second data transfer type (such as bulk transfer type). The method 300 continues in block 330 by wirelessly transferring the second data from the first USB enabled device (such as the HWA) to the second USB enabled device (such as the DWA) using the second data transfer type. The method 300 continues with converting the wirelessly transferred second data to a third data (such as isochronous data) having the first data transfer type.

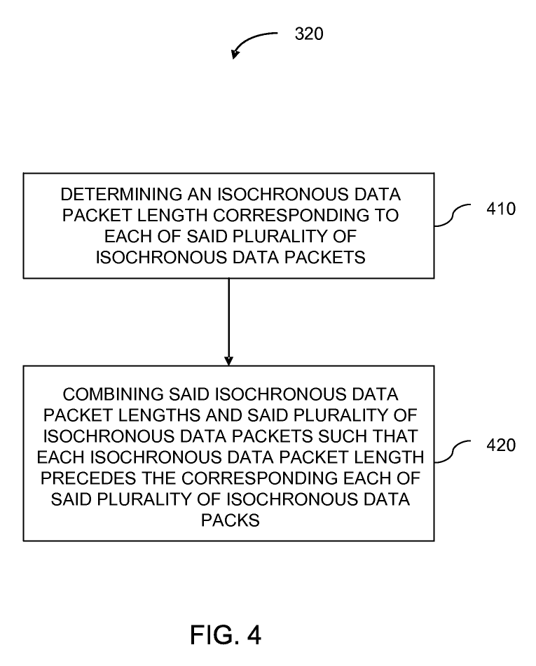

Referring also to FIG. 4, illustrated is a flowchart of a method for converting data that may be used in block 320 of FIG. 3. The method begins in block 410 by determining an isochronous data packet length corresponding to each of the plurality of isochronous data packets. The method continues in block 420 by combining the isochronous data packet lengths and the plurality of isochronous data packets such that each isochronous data packet length precedes the corresponding isochronous data packet.

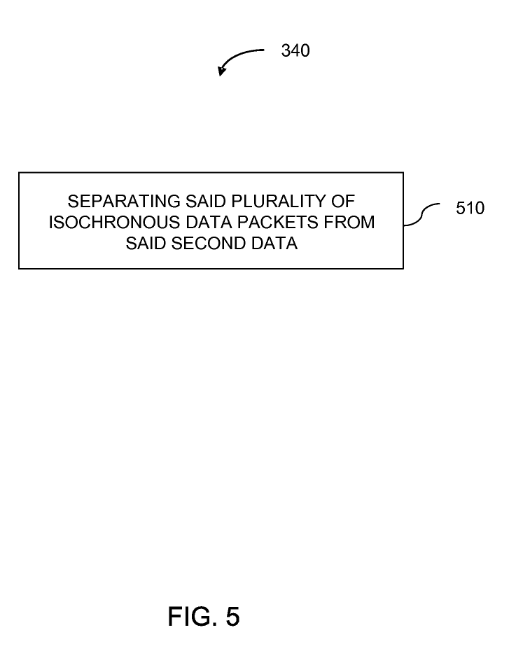

Referring also to FIG. 5, illustrated is a flowchart depicting a method for converting data that may be used in block 340 of FIG. 3. The method includes separating the plurality of isochronous data packets from the second data (such as the isochronous data having the bulk transfer type).

In an alternative embodiment, referring back to FIG. 2, the isochronous data having the bulk data transfer type 214 may be marked with higher priority, promoting them for earlier delivery in WUSB transactions over other data transfer types. For example, a bulk data transfer 218, illustrated in FIG. 2, is provided to the DWA driver 124. As discussed above, the isochronous data transfer having the isochronous data transfer type 210 is also provided to the DWA driver 124. After conversion of the isochronous data transfer 210 into the isochronous data having the bulk data transfer type 214, the DWA driver 124 marks the resulting isochronous data 214 with higher priority for delivery in the WUSB data transfer 200 over other data transfer types. Both the bulk data 220 and the isochronous data having the bulk data transfer type 214 are provided to the HWA driver 116. The HWA driver 116 recognizes the priority of the isochronous data 214 and consequently, promotes the isochronous data having the bulk data transfer type 214 for delivery to the DWA 120 before the bulk data 220.

According to certain embodiments, the wire adapter drivers (e.g., the DWA driver 124 and/or HWA driver 116) may ensure bulk data containing isochronous data is given higher priority than other bulk data. For example, when using wire adapters, the wire adapter drivers may perform the scheduling function to determine which traffic is scheduled next. Thus, during this scheduling, the wire adapter drivers may implement prioritization by scheduling bulk data packets containing isochronous data to be transferred before other bulk data.

According to certain embodiments, bulk data packets containing isochronous data may be given higher priority by inserting them into a high priority queue that is serviced before other queues. According to certain embodiments, to provide further assurance on prioritization, a WUSB host may also enable the prioritization of bulk data packets containing isochronous data in its scheduling algorithm.

According to certain embodiments, a priority of queues may be achieved by actually delaying transfer from one or more of the queues. For example, a (conventional) bulk data queue (used to transfer bulk data that does not contain isochronous data packets) may be restricted from transfer at times by monitoring the memory usage in the DWA and/or HWA. At such times that memory usage is detected, the bulk data queue may be delayed, freeing bandwidth for transfer of bulk data packets (potentially smaller bulk data packets containing isochronous data) from a high priority queue.

Certain types of data transfers may not be re-arranged or split. Therefore, for certain embodiments, a DWA driver may aggregate an isochronous data payload without bypassing any data packet in the bulk data queue (e.g., where the bypassing would result in a split). For example, if the Bulk data queue had previously sent a transfer request header for a data packet initiated by the DWA, in certain cases, that transaction may not be split from its data payload according to a Wire Adapter protocol to the DWA. Thus, in such cases, two markers may be used to transmit packets from the DWA Driver to the HWA Driver: a first marker to indicate Priority and a second marker to indicate the ability to split.

According to certain embodiments, every bulk data transfer sent to the HWA driver may have an I/O request packet (IRP) containing context information for the bulk data transfer. According to certain embodiments, a specific field in the IRP reserved for use as a priority field may be set to indicate a high priority for bulk data transfers containing isochronous data packets.

Alternative embodiments of the present disclosure may include a WUSB system as shown in FIG. 1, having a USB enabled isochronous device that is an audio microphone. Other embodiments may include USB enabled devices that support streaming real time data transfer. Additionally, in an alternative embodiment, the USB enabled host 110 in the WUSB system shown in FIG. 1, may optionally include a native WUSB enabled host, therefore eliminating the need for the HWA 112. Moreover, in another alternative embodiment in accordance with the present disclosure, the USB enabled isochronous device 128 in the WUSB system 100 shown in FIG. 1, includes a native WUSB enabled isochronous device, therefore eliminating the need for the DWA 120.

Moreover, in still another alternative embodiment, the UWB system 100 of FIG. 1 supports isochronous data transfers originating from the DWA 120 and using bulk data transfer to wirelessly transfer isochronous data to the HWA 112.

### EXAMPLE PACKET CONVERSION

As noted above, because of the nature of wireless communications, WUSB isochronous data transfers may require added complexity relative to wired USB isochronous data transfers. Certain embodiments of the present disclosure, however, may allow isochronous data transfers between a host and USB device, using wireless USB bulk data transfer operations.

Using the techniques presented herein, wireless USB bulk data transfers may be utilized to achieve isochronous data transfers between a host and a USB enabled Isochronous device, as if they were directly connected via a wired USB connection.

As described above, for certain embodiments, when preparing converting data from an isochronous transfer type to a bulk data transfer type, data packet lengths may be concatenated with their respective isochronous data packets in a bulk data stream. The isochronous data packets and their respective lengths may then be transferred utilizing a wireless USB bulk data transfer. When receiving a bulk data transfer with isochronous data packets embedded therein, the data packet lengths may allow the receiving entity to extract the corresponding isochronous data packets. For example, the receiving entity may read a data packet length and read the subsequent number of bytes of the corresponding data packet.

FIGS. 6A and 6B illustrate how isochronous data packets may be converted to data packets suitable for bulk data transfer. FIG. 6A illustrates an isochronous data transfer 210 of data packets 212. As illustrated, each data packet 212 has a corresponding length L (e.g., a data packet D1 has a length L1, data packet D2 has a length L2, etc.). The data packets may be transferred, for example, to a host wire adapter, using conventional isochronous data transfer with OUT tokens followed by the data packets (D1 to DN). With isochronous data transfers, the length of each data packet may vary.

As illustrated in FIG. 6B, the isochronous data packets 212 (D1 to DN) may be converted to a bulk data stream 214 with data packet lengths 216 concatenated thereto. The isochronous data packets 212 may then be transferred via bulk data transfers of packets (e.g., D1′). With bulk data transfers, a maximum data packet length (L_{MAX}) may be used for each transfer, when possible. A packet that is less than the maximum data packet length may signal the end of a bulk data transfer. Thus, the number of bulk data transfers required to transmit the isochronous data packets 212 and their corresponding data packet lengths may vary, with L_{MAX} and the actual lengths of the various data packets 212.

For certain embodiments, the receiving device may generate an ACK packet to confirm receipt of the bulk data transfer. However, to support the isochronous nature of the data transfer, rules requiring retransmission of packets with bit errors (e.g., as indicated by a mismatch with a CRC) may be ignored and some portion of the packet or a known packet (e.g., corresponding to silence in an audio or voice data transfers) may be processed regardless.

As noted above, for certain embodiments, bulk data transfers containing isochronous data packets may be marked with a higher priority than other bulk data, in an effort to ensure the data is transferred at a rate sufficient to satisfy bandwidth and latency requirements negotiated between the host and device. According to certain embodiments, every bulk data transfer sent to the HWA driver may have an I/O request packet (IRP) containing context information for the bulk data transfer. According to certain embodiments, a specific field in the IRP reserved for use as a priority field may be set to indicate a high priority for bulk data transfers containing isochronous data packets. Further, for certain embodiments other bulk data may be included in a bulk data transfer containing isochronous data packets. In such embodiments, any suitable technique may be utilized to distinguish between isochronous data packets and the other bulk data packets.

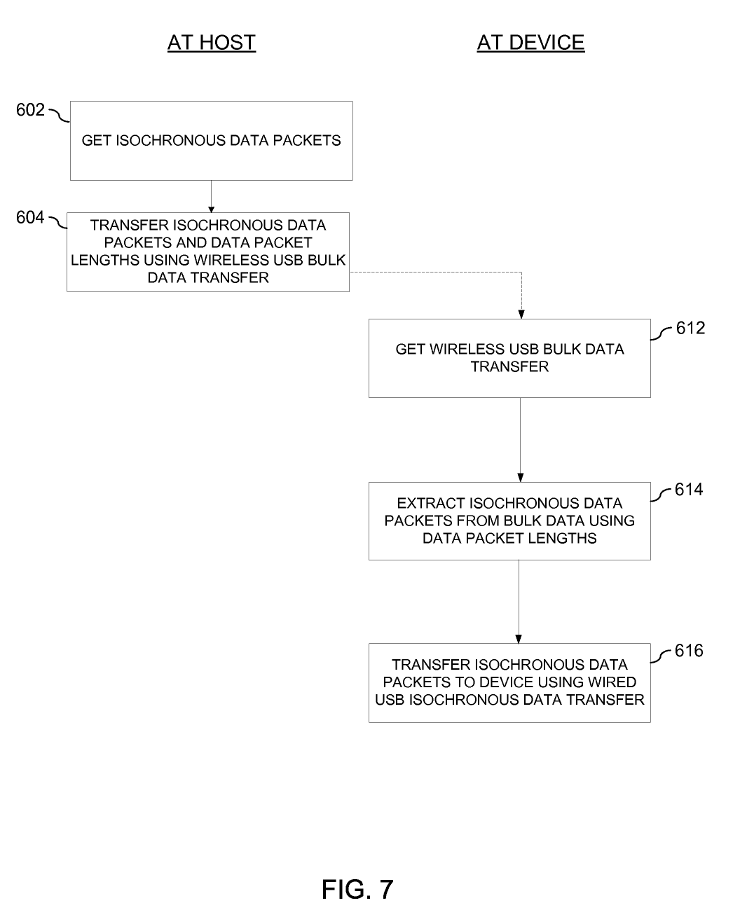

FIG. 7 illustrates example operations for Isochronous (OUT) data transfer from a host to a device, via Wireless USB bulk data transfer, according to certain aspects of the present disclosure. The operations include operations 602-604 that may be performed at a host device (e.g., by a DWA driver, HWA driver, or HWA) and operations 612-616 that may be performed at a USB enabled device (e.g., by a DWA or scheduler of a DWA).

The operations begin, at 602, by obtaining isochronous data packets. The isochronous data packets may be obtained, for example, by an isochronous device driver (that may be running on top of the DWA driver) that gets isochronous data packets from applications. Such isochronous data packets may correspond to, for example, streaming audio (e.g., a music player or telephony application) or video. At 604, the isochronous data packets and data packet lengths are transferred using a wireless USB bulk data transfer.

At 612, the bulk data transfer is received and the isochronous data packets are extracted therefrom using the data packet lengths, at 614. For example, the receiving device may read a data packet length and extract the subsequent corresponding number of bytes as an isochronous data packet and repeat this process to repeat the remaining packets. At 616, the isochronous data packets are transferred to the device using a (conventional) wired USB isochronous data transfer.

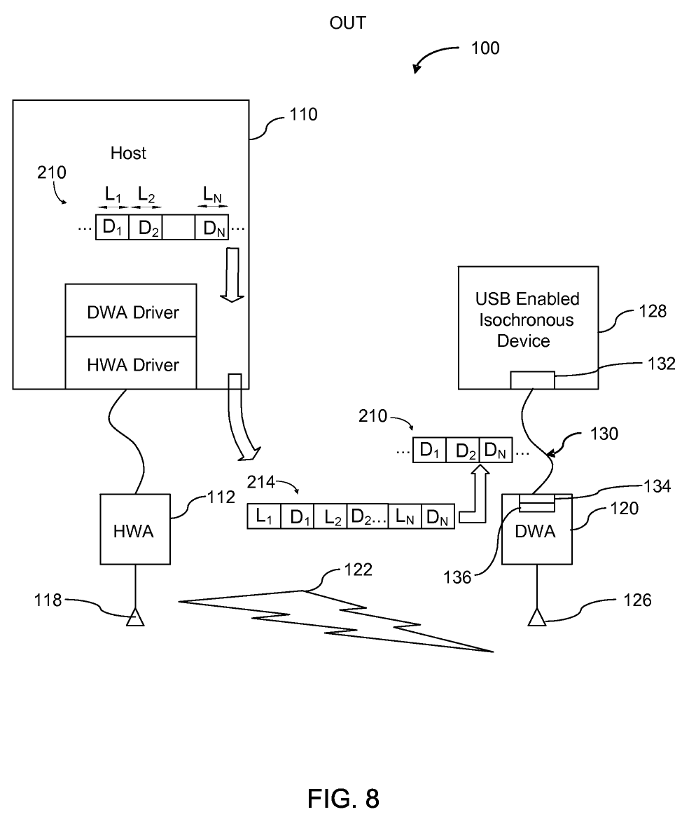

FIG. 8 illustrates a diagram of an example Isochronous (OUT) data transfer from a host to a device, via Wireless USB bulk data transfer operations corresponding to the operations of FIG. 7. As illustrated, a stream 210 of isochronous data packets 212 may be converted to a bulk data transfer stream 214 having isochronous data packets 212 and corresponding data packet lengths 216 concatenated thereto. HWA 112 may transfer the bulk data transfer stream 214 to the DWA 120. At the DWA 120, the isochronous data packets 212 may be extracted and transferred to the USB enabled Isochronous device 128. For example, the scheduler 136 of the DWA 120 shown in FIG. 1 may buffer the isochronous data packets received via a wireless USB bulk data transfer and transfer them according a negotiated rate to the USB enabled Isochronous device 128.

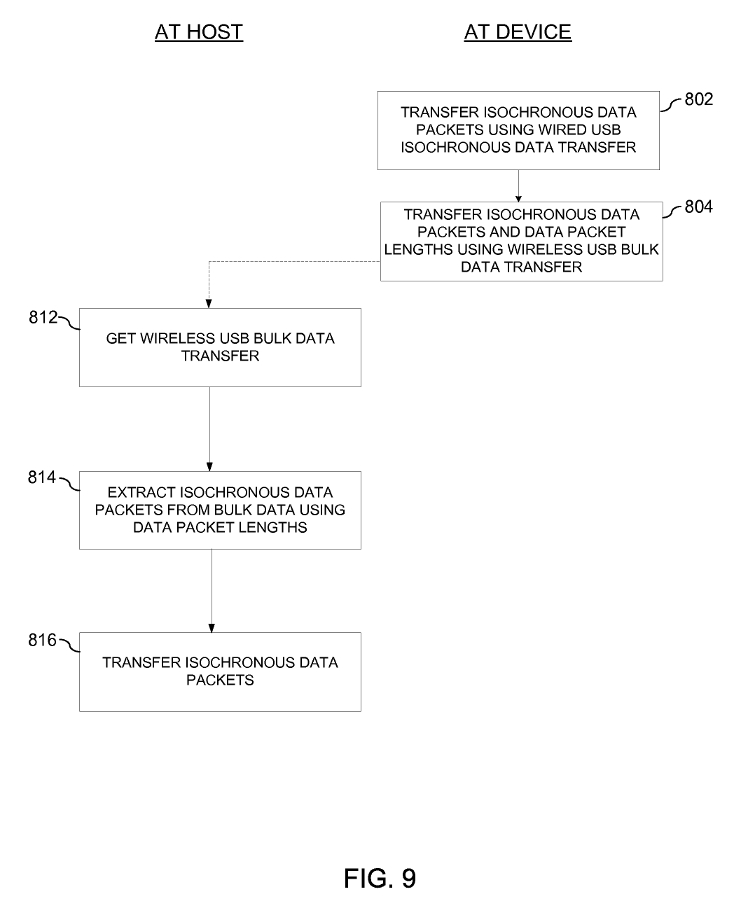

FIG. 9 illustrates example operations for Isochronous (IN) data transfer from a device to a host, via Wireless USB bulk data transfer, according to certain aspects of the present disclosure. The operations include operations 802-804 that may be performed at a USB enabled device (e.g., by a DWA or scheduler of a DWA) and operations 812-816 that may be performed at a host device (e.g., by an HWA).

The operations begin, at 802, by transferring isochronous data packets using wired USB Isochronous data transfer. At 804, the isochronous data packets and data packet lengths are transferred using a wireless USB bulk data transfer.

At 812, the bulk data transfer is received and the isochronous data packets are extracted therefrom using the data packet lengths, at 814. At 816, the isochronous data packets are transferred to the device using a (conventional) wired USB isochronous data transfer.

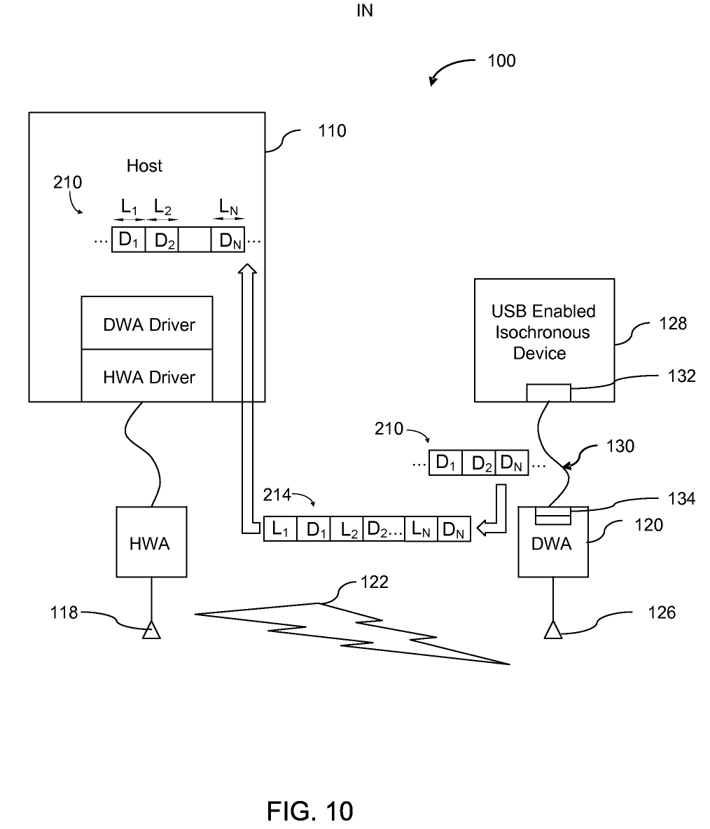

FIG. 10 illustrates a diagram of an example Isochronous (OUT) data transfer from a device to a host, via Wireless USB bulk data transfer operations corresponding to the operations of FIG. 9. As illustrated, a stream 210 of isochronous data packets 212 from the device 128 may be converted to a bulk data transfer stream 214 having isochronous data packets 212 and corresponding data packet lengths 216 concatenated thereto. DWA 120 may transfer the bulk data transfer stream 214 to the HWA 112. The HWA 112 may pass bulk data transfer 214 to the HWA driver and DWA driver and, for example, the DWA driver may extract isochronous data packets 212 to be passed to the host 120. The isochronous data packets may be passed to the host 120 in a metered manner, for example, by a scheduler application that buffers the isochronous data packets received via a wireless USB bulk data transfer and transfer them to the host 120 according a negotiated rate.

Although embodiments of the present disclosure have been described in detail, those skilled in the art should understand that they may make various changes, substitutions and alterations herein without departing from the spirit and scope of the present disclosure. For example, although the particular embodiments illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like. Embodiments disclosed herein have been provided with reference to UWB systems. However, implementations of embodiments disclosed herein are not limited to any particular radio frequency system. Also, several different advantages exist from these and other embodiments. In addition to providing an efficient and cost-effective method and system for transferring isochronous data using bulk data transfer in wireless USB systems, the method and system disclosed herein can be easily implemented with modifications to the DWA and its device driver. Also, with converting the isochronous data transfer to a bulk data transfer type in the device driver, the need for extra endpoints and/or handling in the HWA can be eliminated. Further, the DWA can meter out its delivery synchronization independent of any other timing mechanism such as the Start of Frame synchronization at the USB level within the DWA itself.

According to certain embodiments, a wire adapter may meter the transfer of isochronous data packets to an Isochronous endpoint according to quality of service (QoS) and traffic parameters defined by the Isochronous endpoint.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may be performed by corresponding counterpart means-plus-function components with similar numbering. For example, blocks 300, 320, 340, 600, and 800, shown in FIGS. 3, 4, 5, 7, and 9, respectively, may be performed by corresponding circuit blocks.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure, and recited in the claims below, may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for transferring data in a wireless USB system having a first USB enabled device and a second USB enabled device, comprising:
providing a first data having a first data transfer type;
converting said first data to a second data having a second data transfer type;
wirelessly transferring said second data from said first USB enabled device to said second USB enabled device using said second data transfer type; and
converting said wirelessly transferred second data to a third data having said first data transfer type.

2. The method of claim 1, further comprising transferring said third data to a third USB enabled device using said first data transfer type, said third USB enabled device supporting audio.

3. The method of claim 1, further comprising prioritizing said second data to be wirelessly transferred before a fourth data.

4. The method of claim 1, wherein said providing said first data having said first data transfer type includes providing said first data having an isochronous data transfer type.

5. The method of claim 4, wherein said converting said first data includes converting said first data to said second data having a bulk data transfer type.

6. The method of claim 4, wherein said first data includes a plurality of isochronous data packets, and wherein said converting said first data to said second data includes:
determining an isochronous data packet length corresponding to each of said plurality of isochronous data packets; and
combining said isochronous data packet lengths and said plurality of isochronous data packets such that each isochronous data packet length precedes the corresponding each of said plurality of isochronous data packets.

7. The method of claim 4, wherein said converting said second data to said third data includes separating said plurality of isochronous data packets from said second data.

8. The method of claim 7, further comprising delivering said plurality of isochronous data packets to an endpoint associated with said second USB enabled device, said endpoint supporting said isochronous data transfer type.

9. The method of claim 8, further comprising metering each of said plurality of isochronous data packets for transfer, said metering being performed by an isochronous scheduler.

10. A wireless USB system for transferring data, comprising:
a first USB enabled device that includes:
a first conversion module configured to convert said first data having said first data transfer type to a second data having a second data transfer type; and
a transmitter adapted to wirelessly transfer said second data from said first USB enabled device to said second USB;
a second USB enabled device that includes:
a second conversion module configured to convert said wirelessly transferred second data to a third data having said first data transfer type; and
a receiver adapted to wirelessly receive said second data from said first USB enabled device.

11. The system of claim 10, wherein said first data includes a plurality of first data packets, and wherein said first conversion module configured to convert is configured to:
determine a data packet length corresponding to each of said plurality of first data packets; and
combine said data packet lengths and said plurality of first data packets to form said second data.

12. The system of claim 11, wherein the combination of said data packet lengths and said plurality of first data packets is such that each of said plurality of first data packet lengths precedes the corresponding each of said plurality of first data packets.

13. The system of claim 10, wherein:
said first data transfer type includes isochronous data transfer type;
said second data transfer type includes bulk data transfer type; and
said second conversion module configured to convert is configured to separate said plurality of first data packets from said second data.

14. The system of claim 10, wherein:
said first USB enabled device includes a USB enabled host device;
said second USB enabled device includes a host wire adapter; and
said third USB enabled device includes a device wire adapter.

15. The system of claim 10, wherein said USB enabled host device includes a module configured to prioritize said second data to be wirelessly transferred before a fourth data.

16. A method for transferring data, comprising:
embedding a plurality of isochronous data packets in bulk data packets; and
wirelessly transferring the bulk data packets.

17. The method of claim 16, further comprising receiving the isochronous data packets transmitted using a universal serial bus (USB) isochronous data transfer protocol.

18. The method of claim 16, wherein wirelessly transferring the bulk data packets comprises transmitting the bulk data packets using a universal serial bus (USB) bulk data transfer protocol.

19. The method of claim 16, further comprising prioritizing the bulk data packets containing the isochronous data packets to be wirelessly transferred before other bulk data packets.

20. The method of claim 19, wherein prioritizing the bulk data packets containing the isochronous data packets to be wirelessly transferred before other bulk data packets comprises:
writing the bulk data packets containing the isochronous data packets to a high priority buffer from which data is transferred at a higher priority relative to lower priority buffers.

21. The method of claim 19, wherein prioritizing the bulk data packets containing the isochronous data packets to be wirelessly transferred before other bulk data packets comprises:
setting a priority field in an input/output request packet (IRP) to a value indicating a high priority.

22. The method of claim 16, wherein embedding a plurality of isochronous data packets of an isochronous universal serial bus (USB) data transfer type in bulk data packets of a USB bulk data transfer type comprises:
determining an isochronous data packet length corresponding to each of said plurality of isochronous data packets; and
including said isochronous data packet lengths in the bulk data packets.

23. A method for transferring data, comprising:
receiving bulk data packets;
extracting, from the bulk data packets, isochronous data packets; and
transferring said isochronous data packets to a universal serial bus (USB) enabled device.

24. The method of claim 23, wherein transferring said isochronous data packets to the universal serial bus (USB) enabled device comprises transferring the isochronous data packets using a universal serial bus (USB) isochronous data transfer protocol.

24. The method of claim 23, wherein receiving the bulk data packets comprises receiving the bulk data packets transmitted using a universal serial bus (USB) bulk data transfer protocol.

25. The method of claim 23, further comprising:
metering each of said plurality of isochronous data packets for transfer to the universal serial bus (USB) enabled device.

26. The method of claim 23, wherein the metering is performed according to quality of service (QoS) and traffic parameters defined by an Isochronous endpoint to which the isochronous data packets are transferred.

27. The method of claim 23, wherein extracting, from the bulk data packets, isochronous data packets comprises:
obtaining a length of each isochronous data packet from the bulk data packets; and
extracting a number of bytes of each isochronous data packet corresponding to the length obtained for each isochronous data packet.

28. An apparatus for transferring data, comprising:
a converter for embedding a plurality of isochronous data packets in bulk data packets; and
a transmitter for wirelessly transferring the bulk data packets.

29. The apparatus of claim 28, further comprising a receiver for receiving the isochronous data packets transmitted using a universal serial bus (USB) isochronous data transfer protocol.

30. The apparatus of claim 28, wherein the transmitter is configured to wirelessly transfer the bulk data packets comprises transmitting the bulk data packets using a universal serial bus (USB) bulk data transfer protocol.

31. The apparatus of claim 28, wherein the converter is configured to prioritize the bulk data packets containing the isochronous data packets to be wirelessly transferred before other bulk data packets.

32. The apparatus of claim 31, wherein the converter is configured to prioritize the bulk data packets containing the isochronous data packets to be wirelessly transferred before other bulk data packets by:
writing the bulk data packets containing the isochronous data packets to a high priority buffer from which data is transferred at a higher priority relative to lower priority buffers.

33. The apparatus of claim 31, wherein the converter is configured to prioritize the bulk data packets containing the isochronous data packets to be wirelessly transferred before other bulk data packets by:
setting a priority field in an input/output request packet (IRP) to a value indicating a high priority.

34. The apparatus of claim 28, wherein the converter is configured to:
determine an isochronous data packet length corresponding to each of said plurality of isochronous data packets; and
include said isochronous data packet lengths in the bulk data packets.

35. An apparatus for transferring data, comprising:
a receiver for receiving bulk data packets;
a converter for extracting, from the bulk data packets, isochronous data packets; and
a transmitter for transferring said isochronous data packets to a universal serial bus (USB) enabled device.

36. The apparatus of claim 35, wherein the transmitter is configured to transfer the isochronous data packets using a universal serial bus (USB) isochronous data transfer protocol.

37. The apparatus of claim 35, wherein the receiver is configured to receive bulk data packets transmitted using a universal serial bus (USB) bulk data transfer protocol.

38. The apparatus of claim 35, wherein the transmitter is configured to meter each of said plurality of isochronous data packets for transfer to the universal serial bus (USB) enabled device.

39. The apparatus of claim 38, wherein the transmitter is configured to meter each of said plurality of isochronous data packets according to quality of service (QoS) and traffic parameters defined by an Isochronous endpoint to which the isochronous data packets are transferred.

40. The apparatus of claim 31, wherein the converter is configured to:
obtain a length of each isochronous data packet from the bulk data packets; and
extract a number of bytes of each isochronous data packet corresponding to the length obtained for each isochronous data packet.

41. An apparatus for transferring data, comprising:
means for embedding a plurality of isochronous data packets in bulk data packets; and
means for wirelessly transferring the bulk data packets.

42. The apparatus of claim 41, further comprising means for receiving the isochronous data packets transmitted using a universal serial bus (USB) isochronous data transfer protocol.

43. The apparatus of claim 41, wherein the means for wirelessly transferring is configured to wirelessly transfer the bulk data packets comprises transmitting the bulk data packets using a universal serial bus (USB) bulk data transfer protocol.

44. The apparatus of claim 41, wherein the means for embedding is configured to prioritize the bulk data packets containing the isochronous data packets to be wirelessly transferred before other bulk data packets.

45. The apparatus of claim 44, wherein the means for embedding is configured to prioritize the bulk data packets containing the isochronous data packets to be wirelessly transferred before other bulk data packets by:
writing the bulk data packets containing the isochronous data packets to a high priority buffer from which data is transferred at a higher priority relative to lower priority buffers.

46. The apparatus of claim 44, wherein the means for embedding is configured to prioritize the bulk data packets containing the isochronous data packets to be wirelessly transferred before other bulk data packets by:
setting a priority field in an input/output request packet (IRP) to a value indicating a high priority.

47. The apparatus of claim 41, wherein the means for embedding is configured to:
determine an isochronous data packet length corresponding to each of said plurality of isochronous data packets; and
include said isochronous data packet lengths in the bulk data packets.

48. An apparatus for transferring data, comprising:
means for receiving bulk data packets;
means for extracting, from the bulk data packets, isochronous data packets; and
means for transferring said isochronous data packets to a universal serial bus (USB) enabled device.

49. The apparatus of claim 48, wherein the means for transferring is configured to transfer the isochronous data packets using a universal serial bus (USB) isochronous data transfer protocol.

50. The apparatus of claim 48, wherein the means for receiving is configured to receive bulk data packets transmitted using a universal serial bus (USB) bulk data transfer protocol.

51. The apparatus of claim 48, wherein the means for transferring is configured to meter each of said plurality of isochronous data packets for transfer to the universal serial bus (USB) enabled device.

52. The apparatus of claim 51, wherein the means for transferring is configured to meter each of said plurality of isochronous data packets according to quality of service (QoS) and traffic parameters defined by an Isochronous endpoint to which the isochronous data packets are transferred.

53. The apparatus of claim 48, wherein the means for extracting is configured to:
obtain a length of each isochronous data packet from the bulk data packets; and
extract a number of bytes of each isochronous data packet corresponding to the length obtained for each isochronous data packet.

54. A computer-program product for transferring data, comprising a computer readable medium encoded with instructions executable to:
embed a plurality of isochronous data packets in bulk data packets; and
wirelessly transfer the bulk data packets.

55. A computer-program product for transferring data, comprising a computer readable medium encoded with instructions executable to:
receive bulk data packets;
extract, from the bulk data packets, isochronous data packets; and
transfer said isochronous data packets to a universal serial bus (USB) enabled device.

56. A wireless adapter, comprising:
an antenna;
a converter for embedding a plurality of isochronous data packets in bulk data packets; and
a transmitter for wirelessly transferring the bulk data packets using the antenna.

57. A wireless adapter, comprising:
an antenna;
a receiver for receiving bulk data packets via the antenna;
a converter for extracting, from the bulk data packets, isochronous data packets; and
a transmitter for transferring said isochronous data packets to a universal serial bus (USB) enabled device.
